(19) United States
(12) Patent Application Publication
(10) Pub. No.: US 2014/0287324 A1
(43) Pub. Date: Sep. 25, 2014

(54) ELECTROLYTE-COATED CATHODE ACTIVE MATERIAL PARTICLES, ALL SOLID STATE BATTERY, AND METHOD FOR PRODUCING ELECTROLYTE-COATED CATHODE ACTIVE MATERIAL PARTICLES

(71) Applicants: Yasushi Tsuchida, Susono-shi (JP); Takuo Yanagi, Toyota-shi (JP); Tatsuya Koga, Susono-shi (JP)

(72) Inventors: Yasushi Tsuchida, Susono-shi (JP); Takuo Yanagi, Toyota-shi (JP); Tatsuya Koga, Susono-shi (JP)

(73) Assignee: TOYOTA JIDOSHA KABUSHIKI KAISHA, Toyota-shi, Aichi (JP)

(21) Appl. No.: 14/353,921

(22) PCT Filed: Apr. 26, 2012
(86) PCT No.: PCT/JP2012/061258

§ 371 Date: Apr. 24, 2014

(30) Foreign Application Priority Data
Nov. 17, 2011 (JP) PCT/JP2011/076553

(51) Int. Cl. H01M 10/0562; H01M 10/052

(52) U.S. Cl. CPC H01M 10/0562; H01M 10/052
USPC 429/304; 427/58

(57) ABSTRACT

A main object of the present invention is to provide electrolyte-coated cathode active material particles capable of increasing the discharge capacity of an all solid state battery and of enhancing the battery efficiency. In the present invention, the above object is achieved by providing electrolyte-coated cathode active material particles including cathode active material particles, and a sulfide solid electrolyte layer formed on the surface of the cathode active material particles.

### TECHNICAL FIELD

The present invention relates to electrolyte-coated cathode active material particles that are capable of increasing the discharge capacity of an all solid state battery and of increasing the battery efficiency.

### BACKGROUND ART

Along with the rapid distribution of information-related equipment and telecommunication equipment such as personal computers, video cameras, and mobile telephones in recent years, more emphasis is put on the development of batteries that are utilized as power supplies of the equipments. Furthermore, in the automotive industry, development of high power output and high capacity batteries for electric cars and hybrid cars is underway, and development of lithium batteries with high discharge capacity is underway.

Since lithium batteries that are conventionally commercially available use liquid electrolytes containing flammable organic solvents, improvements in terms of structure and material are needed for the installation of safety devices that suppress temperature increase at the time of short circuits, or for the prevention of short circuits. In this regard, since a lithium battery in which the liquid electrolyte is changed to a solid electrolyte layer to make the battery all-solid, does not use flammable organic solvents in the batteries, it is contemplated that simplification of safety devices is promoted, and excellent production cost or productivity is achieved.

In the field of all solid state batteries as such, attention has been paid for a long time to the interface of a cathode active material and a solid electrolyte, and there have been attempts to promote an enhancement in the performance of all solid state batteries. In the case of a solid electrolyte, it is difficult for the electrolyte to penetrate into the interior of the cathode active material as compared with a liquid electrolyte, and the interface between the cathode active material and the electrolyte is prone to be decreased. Therefore, the area of the interface is increased by using a cathode material containing a mixed powder obtained by mixing a powder of a cathode active material and a powder of a solid electrolyte.

Furthermore, when lithium ions migrate through the interface between a cathode active material and a solid electrolyte, resistance occurs in the interface, and the performance of the all solid state battery is deteriorated thereby. This is because when the cathode active material and the solid electrolyte react, high resistance sites are formed on the surface of the cathode active material.

Patent Literatures 1 and 2 disclose cathode layers each containing a cathode active material coated with a lithium ion conductive oxide layer on the surface, and a sulfide solid electrolyte as a solid electrolyte. In these cathode layers, by forming a lithium ion conductive oxide layer on the surface of a cathode active material, and then mixing the cathode active material with a sulfide solid electrolyte, a reaction between the sulfide solid electrolyte and the cathode active material is suppressed, and the formation of high resistance sites at the surface of the cathode active material layer is suppressed. Furthermore, Patent Literature 3 discloses a cathode layer containing a cathode active material powder and a sulfide solid electrolyte powder having lithium ion conductivity. In this cathode layer, the contact areas between the cathode active material powder particles and the sulfide solid electrolyte powder particles having lithium ion conductivity are increased by adjusting the mixing ratio, and thus an increase in the discharge capacity is attempted.

### CITATION LIST

### Patent Literatures

Patent Literature 1: Japanese Patent Application Publication (JP-A) No. 2009-193940
Patent Literature 2: WO 2007/00459
Patent Literature 3: JP-A No. H08-195219

### SUMMARY OF INVENTION

### Technical Problem

However, the cathode materials described in the aforementioned Patent Literatures 1 to 3 are such that in the cathode layer, the sulfide solid electrolyte and the cathode active material exist in a point contact state, and cannot be made to adhere closely. Therefore, there is a problem that there are few lithium ion conduction paths, and when lithium ions are conducted, high resistance occurs, and the battery efficiency is decreased. Furthermore, since the sulfide solid electrolyte and the cathode active material cannot adhere closely to each other, a large number of voids are generated in the cathode layer, and the packing density of the cathode active material particles cannot be increased. Therefore, there is a problem that an increase in the discharge capacity cannot be promoted.

Furthermore, in the cathode materials described in the Patent Literatures 1 to 3, the interparticle distance of the cathode active material particles in the cathode layer cannot be uniformly adjusted with high accuracy. Therefore, there is a problem that when the interparticle distance is small, there occurs a decrease in lithium ion conductivity, and on the other hand, when the interparticle distance is large, there occurs a decrease in the discharge capacity of the all solid state battery, which is accompanied by a decrease in the packing density of the cathode active material.

The present invention is achieved under such circumstances, and it is an object of the invention to provide electrolyte-coated cathode active material particles that are capable of increasing the discharge capacity of an all solid state battery and of increasing the battery efficiency.

### Solution to Problem

In order to solve the problems described above, the present invention provides an electrolyte-coated cathode active material particle comprising a cathode active material particle, and a sulfide solid electrolyte layer formed on a surface of the cathode active material particle.

According to the present invention, when a sulfide solid electrolyte layer is formed in advance on the surface of the cathode active material particles, the contact between the cathode active material particles and the sulfide solid electrolyte layer becomes compact. Thereby, conductivity of lithium ions is increased, and as the resistance occurring when lithium ions are conducted is suppressed, the battery efficiency can be increased. Furthermore, when the structure described above is adopted, the number of voids in the cathode layer is reduced, the cathode active material particles can be packed more densely, and the packing density is increased. Therefore, a high discharge capacity can be obtained.

According to the present invention, it is preferable that a lithium ion conductive oxide layer be provided between the cathode active material particle and the sulfide solid electrolyte layer. It is because the interface resistance occurring as a result of a reaction between the cathode active material and the solid electrolyte can be suppressed.

According to the present invention, it is preferable that a layer thickness of the sulfide solid electrolyte layer be in the range of 50 nm to 1000 nm. It is because when the layer thickness of the sulfide solid electrolyte layer is adjusted, the interparticle distance of the cathode active material particles in the cathode layer that will be described below can be uniformly adjusted with high accuracy, so that lithium ion conductivity is maintained, and an optimum interparticle distance that gives a high packing density is obtained.

Furthermore, the present invention provides an all solid state battery comprising a cathode layer; an anode layer; and a solid electrolyte layer formed between the cathode layer and the anode layer, the cathode layer containing the electrolyte-coated cathode active material particle described above.

According to the present invention, when the electrolyte-coated cathode active material particle is used, the interparticle distance of adjacent cathode active material particles in the cathode layer can be arranged uniformly with high accuracy, so that the interparticle distance would be an interparticle distance that can maintain lithium ion conductivity and result in a high packing density in the cathode layer. Thereby, an all solid state battery having improved battery efficiency with a high discharge capacity can be obtained.

Furthermore, according to the present invention, there is provided an all solid state battery comprising a cathode layer containing a cathode active material particle and a sulfide solid electrolyte; an anode; and a solid electrolyte layer formed between the cathode layer and the anode layer, characterized in that in a cross-sectional region of the cathode layer, when an area of the sulfide solid electrolyte present in a region in which a distance between the cathode active material particles is 1000 nm or less is designated as S_{A}, and a total area of the sulfide solid electrolyte is designated as S_{B}, a ratio S_{A}/S_{B} is 0.1 or greater.

According to the present invention, when the ratio S_{A}/S_{B} is in a predetermined range, the interparticle distance of adjacent cathode active material particles can be arranged uniformly with high accuracy, so that the interparticle distance would be an interparticle distance that can maintain lithium ion conductivity and result in a high packing density in the cathode layer. Thereby, an all solid state battery having improved battery efficiency with a high discharge capacity can be obtained.

Furthermore, according to the present invention, there is provided a method for producing an electrolyte-coated cathode active material particle, the method comprising a coating step of subjecting a mixture of a cathode active material particle and a sulfide solid electrolyte to a shear force imparting treatment, and coating a surface of the cathode active material particle with the sulfide solid electrolyte.

According to the present invention, a sulfide solid electrolyte layer can be formed to closely adhere to the surface of the cathode active material particle by performing the coating step described above. Thereby, the resistance occurring when lithium ions are conducted is suppressed, and the battery efficiency can be increased. Furthermore, when the sulfide solid electrolyte layer is allowed to adhere closely, the number of voids in the cathode layer is reduced, and the packing density of the cathode active material particle is increased. Therefore, a high discharge capacity can be obtained.

Furthermore, by performing the coating step, the layer thickness of the sulfide solid electrolyte layer formed on the surface of the cathode active material particle can be adjusted, and when the electrolyte-coated cathode active material particles are brought into contact with each other in the cathode layer, the cathode active material particles can be arranged uniformly with high accuracy at an appropriate interparticle distance that maintains lithium ion conductivity and gives a high packing density.

### Advantageous Effects of Invention

The present invention provides an effect in which electrolyte-coated cathode active material particles that are capable of increasing the discharge capacity of an all solid state battery and of increasing the battery efficiency, can be obtained.

### BRIEF DESCRIPTION OF DRAWINGS

FIG. 1 is a schematic cross-sectional diagram illustrating an example of the electrolyte-coated cathode active material particles of the present invention.

FIGS. 2A and 2B are schematic cross-sectional diagrams each illustrating an example of the all solid state battery of the present invention.

FIGS. 3A and 3B are schematic cross-sectional diagrams each illustrating an example of adjacent electrolyte-coated cathode active material particles.

FIG. 4 is a diagram showing the results of a TEM analysis of electrolyte-coated cathode active material particles.

FIG. 5 is a graph showing the provisional calculation values of the lithium ion conductivity retention ratio with respect to the layer thickness of the sulfide solid electrolyte layer.

FIGS. 6A and 6B are diagrams showing the results of an SEM analysis of cross-sections of the cathode layers obtained in Example 1 and Comparative Example.

FIG. 7 is a graph showing the discharge capacities of the batteries for evaluation obtained in Example 1, Example 2, and Comparative Example.

FIG. 8 is a graph showing the reaction resistance values of the batteries for evaluation obtained in Example 1, Example 2, and Comparative Example.

### DESCRIPTION OF EMBODIMENTS

Hereinafter, the electrolyte-coated cathode active material particles, all solid state battery, and method for producing electrolyte-coated cathode active material particles of the present invention will be explained in detail.

A. Electrolyte-Coated Cathode Active Material Particles

The electrolyte-coated cathode active material particle of the present invention comprises a cathode active material particle, and a sulfide solid electrolyte layer formed on a surface of the cathode active material particle, and a charge-discharge reaction is carried out through insertion and extraction of lithium ions.

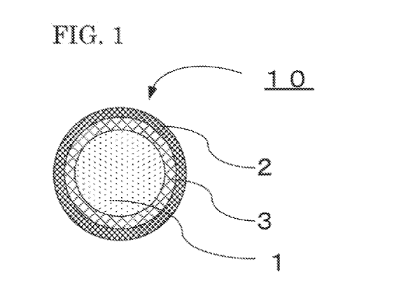

FIG. 1 is a schematic cross-sectional diagram illustrating an example of the electrolyte-coated cathode active material particles of the present invention. The electrolyte-coated cathode active material particles 10 illustrated in FIG. 1 comprises cathode active material particles 1; a sulfide solid electrolyte layer 2 formed on the surface of the cathode active material particles; and a lithium ion conductive oxide layer 3 formed between the cathode active material particles 1 and the sulfide solid electrolyte layer 2.

According to the present invention, the battery efficiency and discharge capacity of an all solid state battery can be enhanced by forming a sulfide solid electrolyte layer to closely adhere to the surface of cathode active material particles.

It is contemplated that in the cathode layers described in Patent Literatures 1 to 3, the sulfide solid electrolyte and the cathode active material particles that had been separately incorporated are in point contact. Therefore, it is thought that sufficient lithium ion conduction paths are not obtained, and when lithium ions are conducted, high resistance occurs, thereby the battery efficiency being decreased. Furthermore, in a cathode layer in which a sulfide solid electrolyte and cathode active material particles are incorporated separately, the number of voids increases, and an increase in the packing density of the cathode active material particles cannot be promoted. Therefore, it is difficult to increase the discharge capacity.

On the contrary, in the electrolyte-coated cathode active material particles of the present invention, when a sulfide solid electrolyte layer is directly formed in advance to closely adhere to the surface of cathode active material particles, the number of lithium ion conduction paths is increased, the resistance occurring at the time of lithium ion conduction is suppressed, and thus, lithium ion conductivity and battery efficiency can be enhanced. Furthermore, when the sulfide solid electrolyte layer is allowed to adhere closely to the cathode active material particles, the number of voids is reduced, and the packing density of the cathode active material particles can be increased, as compared with the case in which the cathode active material and the sulfide solid electrolyte are separately incorporated into the cathode layer. Therefore, a high discharge capacity can be obtained.

Furthermore, when the sulfide solid electrolyte layer is coated on the surface of the cathode active material particles, since the layer thickness can be adjusted, the layer thickness of the sulfide solid electrolyte layer in the cathode layer, that is, the interparticle distance of the cathode active material particles that are brought into contact with the sulfide solid electrolyte layer interposed between the particles, can be adjusted and arranged uniformly with high accuracy to an appropriate distance.

In the cathode layers described in Patent Literatures 1 to 3, since the layer thickness of the sulfide solid electrolyte layer cannot be adjusted, the interparticle distance of the cathode active material particles that are brought into contact with the sulfide solid electrolyte layer interposed between the particles cannot be adjusted uniformly with high accuracy. Therefore, if the interparticle distance is too small, the cross-sectional area of the sulfide solid electrolyte layer that can conduct lithium ions is also reduced. Accordingly, lithium ion conductivity is decreased, and the battery efficiency of the all solid state battery is decreased. On the other hand, if the distance between the cathode active material particles is too large, there is no change observed in the increase of lithium ion conductivity; however, since the packing density of the cathode active material particles in the cathode layer is decreased due to the large interparticle distance, the discharge capacity of the all solid state battery is decreased.

On the contrary, in the electrolyte-coated cathode active material particles of the present invention, when the sulfide solid electrolyte layer is coated on the surface of the cathode active material particles, since the layer thickness of the layer can be adjusted, the cathode active material particles can be arranged uniformly with high accuracy at an appropriate distance in the cathode layer, and thus lithium ion conductivity can be maintained, while a high discharge capacity can be obtained.

Hereinbelow, the respective members for each configuration will be explained.

1. Sulfide Solid Electrolyte Layer

The sulfide solid electrolyte layer used in the present invention contains a sulfide solid electrolyte, and has a function of enhancing lithium ion conductivity when the sulfide solid electrolyte layer is formed on the surface of the cathode active material particles that will be described below.

According to the present invention, when a sulfide solid electrolyte layer is formed to closely adhere to the surface of cathode active material particles, the number of lithium ion conduction paths can be increased, and the conductivity of lithium ions and the battery efficiency can be enhanced. Furthermore, when a sulfide solid electrolyte layer is formed to closely adhere to the surface of cathode active material particles, the number of voids in the cathode layer that will be described below is reduced, and the packing density of the cathode active material particles can be increased.

Regarding the sulfide solid electrolyte layer used in the present invention, it is preferable to use an amorphous sulfide solid electrolyte that substantially does not contain crosslinked sulfur. It is because an amorphous sulfide solid electrolyte is chemically stable and is soft due to being amorphous, and an amorphous sulfide solid electrolyte contributes to the prevention of electrode cracking or an enhancement of battery efficiency.

Furthermore, the lithium ion conductivity at normal temperature of the sulfide solid electrolyte according to the present invention is, for example, preferably 1×10⁻⁵ S/cm or higher, and more preferably 1×10⁻⁴ S/cm or higher.

Furthermore, the sulfide solid electrolyte according to the present invention is preferably amorphous as described above. In order to make the solid electrolyte amorphous, an amorphization treatment may be carried out using the raw material composition described above. Examples of the amorphization treatment include a mechanical milling method and a dissolution and rapid cooling method, and among them, a mechanical milling method is preferred. It is because the treatment can be carried out at normal temperature, and simplification of the production process can be promoted.

Incidentally, whether the “sulfide solid electrolyte is amorphous” can be confirmed by, for example, an X-ray diffraction (XRD) analysis, an electron beam diffraction or the like.

The sulfide solid electrolyte layer according to the present invention contains at least a sulfide solid electrolyte, and examples include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that “m” and “n” represent positive numbers; and Z represents any of Ge, Zn and Ga), Li₂S—GeS₂, Li₂S—SiS₂—Li₃PO₄, and Li₂S—SiS₂—LiₓMO_{y} (provided that “x” and “y” represent positive numbers; and M represents any of P, Si, Ge, B, Al, Ga and In.).

Incidentally, the description of “Li₂S—P₂S₅” means a sulfide solid electrolyte formed-using a raw material composition containing Li₂S and P₂S₅, and the same also applies to other descriptions.

Furthermore, when the sulfide solid electrolyte is formed using a raw material composition containing Li₂S and P₂S₅, the proportion of Li₂S relative to the sum of Li₂S and P₂S₅ is, for example, preferably in the range of 70 mol % to 80 mol %, more preferably in the range of 72 mol % to 78 mol %, and even more preferably in the range of 74 mol % to 76 mol %. It is because a sulfide solid electrolyte containing an ortho-composition or a composition approximating to an ortho-composition can be obtained, and a sulfide solid electrolyte having high chemical stability can be obtained. Here, the term ortho generally refers to an oxo acid having the highest degree of hydration among the oxo acids obtainable by hydrating a same oxide. According to the present invention, a crystal composition in which Li₂S is added to a sulfide to the largest extent is referred to an ortho-composition. In a Li₂S—P₂S₅ system, Li₃PS₄ corresponds to the ortho-composition. In the case of a sulfide solid electrolyte of the Li₂S—P₂S₅ system, the proportion of Li₂S and P₂S₅ from which the ortho-composition is obtained is such that, on a molar basis, Li₂S:P₂S₅=75:25.

Incidentally, even in the case in which Al₂S₃ or B₂S₃ is used instead of P₂S₅ in the raw material composition, a preferred range is the same. In a Li₂S—Al₂S₃ system, Li₃AlS₃ corresponds to the ortho-composition, and in a Li₂S—B₂S₃ system, Li₃BS₃ corresponds to the ortho-composition.

Furthermore, when the sulfide solid electrolyte is formed using a raw material composition containing Li₂S and SiS₂, the proportion of Li₂S relative to the sum of Li₂S and SiS₂ is, for example, preferably in the range of 60 mol % to 72 mol %, more preferably in the range of 62 mol % to 70 mol %, and even more preferably in the range of 64 mol % to 68 mol %. It is because a sulfide solid electrolyte containing an ortho-composition or a composition approximating to an ortho-composition can be obtained, and a sulfide solid electrolyte having high chemical stability can be obtained. In a Li₂S—SiS₂ system, Li₄SiS₄ corresponds to the ortho-composition. In the case of a sulfide solid electrolyte of a Li₂S—SiS₂ system, the proportion of Li₂S and SiS₂ from which the ortho-composition is obtained is such that, on a molar basis, Li₂S:SiS₂=66.7:33.3.

Incidentally, even in the case in which GeS₂ is used instead of SiS₂ in the raw material composition, a preferred range is the same. In a Li₂S—GeS₂ system, Li₄GeS₄ corresponds to the ortho-composition.

Furthermore, when the sulfide solid electrolyte is formed using a raw material composition containing LiX (X=Cl, Br or I), the proportion of LiX is, for example, preferably in the range of 1 mol % to 60 mol %, more preferably in the range of 5 mol % to 50 mol %, and even more preferably in the range of 10 mol % to 40 mol %. Furthermore, when the sulfide solid electrolyte is formed using a raw material composition containing Li₂O, the proportion of Li₂O is, for example, preferably in the range of 1 mol % to 25 mol %, and more preferably in the range of 3 mol % to 15 mol %.

The sulfide solid electrolyte layer according to the present invention may include a conduction aid in addition to the sulfide solid electrolyte. It is because the electron conductivity in the sulfide solid electrolyte layer can be enhanced. The conduction aid is not particularly limited, but examples include carbon materials such as multilayer carbon nanotubes, mesocarbon microbeads (MCMB), acetylene black, Ketjen black, carbon black, cokes, gas phase-grown carbon, and graphite; and metal materials having low reactivity with sulfide solid electrolytes, such as Ti, Al and SUS.

The coating ratio of the sulfide solid electrolyte layer on the surface of the cathode active material particles is, for example, preferably 30% or more, more preferably 50% or more, and even more preferably 70% or more, and it is particularly preferable that the sulfide solid electrolyte layer coat the entire surface of the cathode active material particles. Incidentally, the coating ratio refers to an average coating ratio.

If the coating ratio of the sulfide solid electrolyte layer is less than the range, there are more areas where the sulfide solid electrolyte layer is not formed on the surface of the cathode active material particles, and the resistance to the conduction of lithium ions is increased in the areas that are not coated. Therefore, there is a possibility that the battery efficiency may be decreased.

Incidentally, examples of the method for measuring the coating ratio of the sulfide solid electrolyte layer include transmission electron microscopy (TEM) and X-ray photoelectron spectroscopy (XPS).

The layer thickness of the sulfide solid electrolyte layer on the surface of the cathode active material particles is, for example, preferably in the range of 50 nm to 1000 nm, more preferably in the range of 100 nm to 900 nm, even more preferably in the range of 200 nm to 800 nm, and particularly preferably in the range of 250 nm to 800 nm.

It is because if the layer thickness of the sulfide solid electrolyte layer is excessively larger than the range described above, the cathode active material particles that are brought into contact with the sulfide solid electrolyte layer interposed between the particles, cannot be arranged uniformly with accuracy at an appropriate interparticle distance, and the packing density of the cathode active material particles is decreased, so that there is a possibility that a high discharge capacity may not be obtained. On the other hand, if the layer thickness is excessively smaller than the above-mentioned range, lithium ion conductivity is decreased.

Incidentally, examples of the method for measuring the layer thickness of the sulfide solid electrolyte layer include an image analysis using transmission electron microscopy (TEM). The layer thickness refers to an average layer thickness, and specifically, the layer thickness is preferably the average layer thickness of 20 or more samples. Furthermore, in regard to the sulfide solid electrolyte layer that coats the surface of the cathode active material particles, the proportion of regions having a layer thickness of larger than 1000 nm is preferably 30% or less, more preferably 15% or less, and even more preferably 10% or less. Furthermore, the proportion may also be 0%.

2. Cathode Active Material Particles

Next, the cathode active material particles according to the present invention will be explained. The cathode active material particles according to the present invention are particles that have the above-mentioned sulfide solid electrolyte layer formed on the surface, and carry out insertion and extraction of lithium ions.

The kind of the cathode active material particles used in the present invention is not particularly limited as long as the charge-discharge potential exhibits a noble potential as compared with the charge-discharge potential of the anode active material contained in the anode layer described in section “B. All solid state battery” that will be described below. Examples include oxide-based cathode active material particles and sulfide-based cathode active material particles. Among them, it is preferable to use oxide-based cathode active material particles. It is because an all solid state battery which is likely to form a high resistance layer by reacting with the sulfide solid electrolyte layer, and has a large discharge capacity, can be obtained.

Examples of the oxide-based cathode active material particles used in the present invention include particles of a cathode active material represented by a general formula: LiₓM_{y}O_{z} (in which M represents a transition metal element; x=0.02 to 2.2; y=1 to 2; and z=1.4 to 4). In the above formula, M is preferably at least one selected from the group consisting of Co, Mn, Ni, V, Fe and Si, and more preferably at least one selected from the group consisting of Co, Ni and Mn. Furthermore, for the oxide cathode active material particles, particles of a cathode active material represented by a general formula: Li₁₊ₓMn_{2-x-y}M_{y}O₄ (in which M represents at least one selected from the group consisting of Al, Mg, Co, Fe, Ni and Zn; 0≦x≦1, 0≦y≦2, and 0≦x+y≦2) may be used. Specific examples include layered cathode active material particles such as LiCoO₂, LiMnO₂, LiNiO₂, LiVO₂, and LiNi_{1/3}Co_{1/3}Mn_{1/3}O₂; and spinel type cathode active material particles such as LiMn₂O₄, Li(Ni_{0.5}Mn_{1.5})O₄, Li₂FeSiO₄, and Li₂MnSiO₄. Furthermore, examples of the cathode active material particles other than the material of formula: LiₓM_{y}O_{z} include olivine type cathode active material particles such as LiFePO₄ and LiMnPO₄.

The cathode active material particles used in the present invention are preferably in a true spherical form or an elliptical form, and the average particle size is, for example, preferably in the range of 1 nm to 100 μm, and more preferably in the range of 10 nm to 30 μm.

Incidentally, the average particle size of the cathode active material particles can be determined using, for example, a particle size distribution meter.

3. Electrolyte-Coated Cathode Active Material Particles

The electrolyte-coated cathode active material particles of the present invention are preferably in a true spherical form or an elliptical form, and can be suitably used in, for example, an all solid state battery.

It is preferable that the electrolyte-coated cathode active material particles have a lithium ion conductive oxide layer between the cathode active material particles and the sulfide solid electrolyte layer. The sulfide solid electrolyte layer easily reacts with the cathode active material particles, and when the sulfide solid electrolyte layer is directly coated on the surface of the cathode active material particles, a high interface resistance layer is formed between the sulfide solid electrolyte layer and the cathode active material particles, so that there is a possibility of causing a decrease in the power output. On the contrary, when a lithium ion conductive oxide layer is provided between the cathode active material particles and the sulfide solid electrolyte layer, the lithium ion conductive oxide layer prevents a reaction between the cathode active material particles and the sulfide solid electrolyte, suppresses the production of a high interface resistance layer, and thus can suppress a decrease in the power output.

The lithium ion conductive oxide layer according to the present invention is a layer formed from a lithium ion conductive oxide. The lithium ion conductive oxide is not particularly limited as long as an increase in the interface resistance between the cathode active material particles and the sulfide solid electrolyte layer can be suppressed, and examples include an oxide containing lithium ion, a transition metal element, and oxygen element. When the lithium ion conductive oxide layer contains lithium ion, there is an advantage that lithium ion conductivity is enhanced. Specific examples of such an oxide include LiNbO₃ and Li₄Ti₅O₁₂, and among them, LiNbO₃ is preferred. It is because an increase in the interface resistance can be further suppressed. Furthermore, according to the present invention, Li₂PO₄, Li₄SiO₄ and the like can also be used as the oxide containing lithium ion.

It is more preferable that the lithium ion conductive oxide layer according to the present invention coat a larger area of the surface of the cathode active material particles, and the specific coating ratio is preferably 40% or more, more preferably 70% or more, and even more preferably 90% or more. It is particularly preferable that the lithium ion conductive oxide layer coat the entire surface of the cathode active material particles. Incidentally, the coating ratio refers to an average coating ratio.

Examples of the method for measuring the coating ratio of the lithium ion conductive oxide layer include transmission electron microscopy (TEM) and X-ray photoelectron spectroscopy (XPS).

In regard to the electrolyte-coated cathode active material particles of the present invention, the layer thickness of the lithium ion conductive oxide layer is not particularly limited as long as it is a layer thickness of the extent that does not cause interface resistance as a result of a reaction between the cathode active material particles and the sulfide solid electrolyte layer, and for example, the layer thickness is preferably in the range of 1 nm to 500 nm, and more preferably in the range of 2 nm to 100 nm. It is because if the layer thickness is less than the range described above, there is a possibility that the cathode active material particles and the sulfide solid electrolyte layer may react and cause interface resistance. On the other hand, it is because if the layer thickness exceeds the range described above, there is a possibility that lithium ion conductivity may decrease, or a possibility that the interparticle distance of the cathode active material particles in the cathode layer that will be described below may be increased, and the packing density of the cathode active material particles may be decreased, so that a high discharge capacity cannot be obtained.

Incidentally, examples of the method for measuring the layer thickness of the lithium ion conductive oxide layer include an image analysis using transmission electron microscopy (TEM). Incidentally, the layer thickness refers to an average layer thickness.

B. All Solid State Battery

The all solid state battery of the present invention has three embodiments.

Hereinbelow, the three embodiments will be respectively explained.

### 1. First Embodiment

A first embodiment of the all solid state battery of the present invention is an all solid state battery comprising a cathode layer; an anode layer; and a solid electrolyte layer formed between the cathode layer and the anode layer, characterized in that the cathode layer contains the electrolyte-coated cathode active material particles described above.

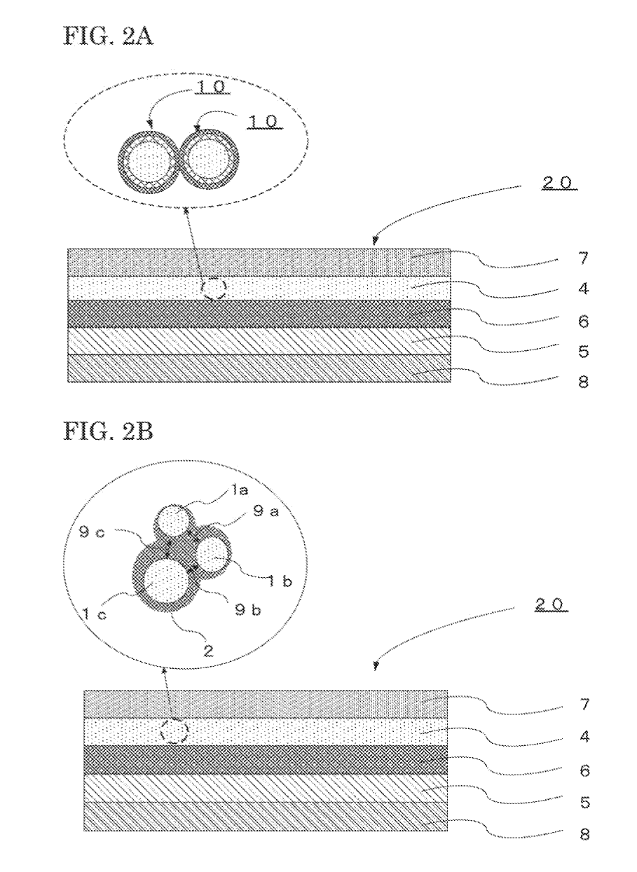

FIG. 2A is a schematic cross-sectional diagram illustrating an example of the first embodiment of the all solid state battery of the present invention. The all solid state battery 20 illustrated in FIG. 2A comprises a cathode layer 4; an anode layer 5; a solid electrolyte layer 6 formed between the cathode layer 4 and the anode layer 5; a cathode current collector 7 that performs current collection of the cathode layer 4; and an anode current collector 8 that performs current collection of the anode layer 5. The present invention is characterized in that the cathode layer 4 contains the electrolyte-coated cathode active material particles 10 described in the above section “A. Electrolyte-coated cathode active material particles”.

According to the present invention, when the cathode layer of an all solid state battery contains the electrolyte-coated cathode active material particles described above, an all solid state battery having high battery efficiency and a high discharge capacity can be obtained.

The electrolyte-coated cathode active material particles of the present invention comprises cathode active material particles and a sulfide solid electrolyte layer formed on the surface of the cathode active material particles, and when the sulfide solid electrolyte layer closely adheres to the surface of the cathode active material particles, the number of lithium ion conduction paths is increased. Thereby, conductivity of lithium ions is enhanced, and the resistance occurring when lithium ions are conducted can be suppressed. Therefore, the battery efficiency of the all solid state battery can be enhanced.

Furthermore, when the sulfide solid electrolyte layer is formed in advance to adhere closely to the surface of the cathode active material particles, the number of voids in the cathode layer is reduced, the packing density of the cathode active material particles can be increased, and a high discharge capacity can be obtained.

Hereinbelow, the respective configurations of the first embodiment of the all solid state battery of the present invention will be explained.

(1) Cathode Layer

The cathode layer according to the first embodiment of the all solid state battery of the present invention is a layer containing at least the electrolyte-coated cathode active material particles described above. In the cathode layer, when two particles of the electrolyte-coated cathode active material particles come adjacent to each other, the cathode active material particle contained in one electrolyte-coated cathode active material particle is brought into contact with the cathode active material particle contained in another electrolyte-coated cathode active material particle, with the sulfide solid electrolyte layer interposed between the particles.

The cathode layer according to the present invention may be formed only from the electrolyte-coated cathode active material particles described above, or may further contain at least one of a conduction aid and a binding material as necessary.

Examples of the binding material include fluorine-containing binding materials such as PTFE and PVDF. Examples of the conduction aid include carbon materials such as multilayer carbon nanotubes, mesocarbon microbeads (MCMB), acetylene black, Ketjen black, carbon black, cokes, gas phase-grown carbon, and graphite; and metal materials with low reactivity with sulfide solid electrolytes, such as Ti, Al and SUS. Furthermore, the cathode layer according to the present invention may contain a solid electrolyte, and the solid electrolyte is preferably a sulfide solid electrolyte that remains without being coated on the surface of the cathode active material particles during the coating step, in connection with the “C. Method for producing electrolyte-coated cathode active material particles” that will be described below.

The contents of the conduction aid and the binding material in the cathode layer are not particularly limited, but for example, the contents are preferably in the range of 0.1% by mass to 20% by mass.

Furthermore, the content of the electrolyte-coated cathode active material particles in the cathode layer is an amount obtained by subtracting the content of other materials described above from the total amount (100% by mass) of the cathode layer.

The layer thickness of the cathode layer according to the present invention is, for example, preferably in the range of 0.1 μm to 1000 μm, and more preferably 1 μm to 100 μm.

Incidentally, examples of the method for measuring the layer thickness of the cathode layer include an image analysis using transmission electron microscopy (TEM).

Regarding the method for forming the cathode layer, any general method can be used. For example, the cathode layer can be formed by adding a cathode mix material including the above-mentioned electrolyte-coated cathode active material particles, a binding material, a conduction aid and the like, on one surface of the solid electrolyte layer that will be described below, and pressing the assembly.

(2) Anode Layer

The anode layer according to the present invention is a layer containing at least an anode active material, and may further contain at least one of a solid electrolyte, a conduction aid and a binding material as necessary. The kind of the anode active material is not particularly limited as long as the anode active material can be used in an all solid state battery, and the charge-discharge potential is a lower potential as compared with the charge-discharge potential of the cathode active material particles contained in the cathode layer. Examples include carbon active materials, oxide active materials, and metal active materials. Examples of the active carbon active materials include mesocarbon microbeads (MCMB), highly blendable graphite (HOPG), hard carbon, and soft carbon. Furthermore, examples of the oxide active materials include Nb₂O₅, Li₄Ti₅O₁₂, and SiO. Examples of the metal active materials include Li alloys, In, Al, Si, and Sn.

An example of the shape of the anode active material described above may be a particulate shape, and the average particle size of the anode active material is, for example, preferably in the range of 1 nm to 100 μm, and more preferably in the range of 10 nm to 30 μm.

Furthermore, the content of the anode active material in the anode layer is not particularly limited, but the content is, for example, preferably in the range of 10% by mass to 99% by mass, and more preferably in the range of 20% by mass to 90% by mass.

It is preferable that the anode layer according to the present invention may contain a solid electrolyte. It is because when a solid electrolyte is incorporated, the lithium ion conductivity in the anode layer can be enhanced. The kind of the incorporated solid electrolyte is not particularly limited as long as the solid electrolyte exhibits lithium ion conductivity, and the solid electrolyte may be a sulfide solid electrolyte or may be any other solid electrolyte. However, it is preferable to use the sulfide solid electrolyte described in the above section “A. Electrolyte-coated cathode active material particles”.

Furthermore, the anode layer may further contain at least one of a conduction aid and a binding material.

Incidentally, in regard to the conduction aid and the binding material used in the anode layer, since the same matters as those described in the above section “1. Cathode layer” are applicable, further description will not be repeated here.

The layer thickness of the anode layer according to the present invention is, for example, preferably in the range of 0.1 μm to 1000 μm, and more preferably in the range of 1 μm to 100 μm.

Incidentally, examples of the method for measuring the layer thickness of the anode layer include an image analysis using transmission electron microscopy (TEM).

Regarding the method for forming the anode layer according to the present invention, any general method can be used. For example, an anode layer can be formed by adding an anode mix material including the anode active material described above, a solid electrolyte, a binding material, a conduction aid and the like on a surface of the solid electrolyte layer that will be described below, which is other than the surface to which the cathode mix material has been added, and pressing the assembly.

(3) Solid Electrolyte Layer

The solid electrolyte layer according to the present invention is a layer formed between the cathode layer and the anode layer, and is a layer containing at least a solid electrolyte. The kind of the incorporated solid electrolyte is not particularly limited as long as the solid electrolyte exhibits lithium ion conductivity, and the solid electrolyte may be a sulfide solid electrolyte, or may be another solid electrolyte. However, it is preferable to use the sulfide solid electrolyte described in the above section “A. Electrolyte-coated cathode active material particles”. Furthermore, for a solid electrolyte other than the sulfide solid electrolyte, the same material as the solid electrolyte used in general all solid state batteries can be used.

The content of the solid electrolyte contained in the solid electrolyte layer according to the present invention is, for example, preferably 60% by mass or more, among others 70% by mass or more, and particularly 80% by mass or more. The solid electrolyte layer may contain a binding material, or may be composed only of a solid electrolyte.

The layer thickness of the solid electrolyte layer according to the present invention may vary greatly depending on the configuration of the all solid state battery, but the layer thickness is, for example, preferably in the range of 0.1 μm to 1000 μm, and among others, the layer thickness is preferably in the range of 0.1 μm to 300 μm.

Incidentally, examples of the method for measuring the layer thickness of the solid electrolyte layer include an image analysis using transmission electron microscopy (TEM). Incidentally, the layer thickness refers to an average layer thickness.

Regarding the method for forming a solid electrolyte layer, any general method can be used. For example, a solid electrolyte layer can be formed by pressing materials including the above-mentioned solid electrolyte and a binding material.

(4) Other Configurations

A first embodiment of the all solid state battery of the present invention comprises at least the cathode layer, anode layer and solid electrolyte layer described above. Furthermore, the all solid state battery may further comprise a cathode current collector that performs current collection of the cathode layer, and an anode current collector that performs current collection of the anode layer. Examples of the material of the cathode current collector include SUS, aluminum, nickel, iron, titanium, and carbon. On the other hand, examples of the material of the anode current collector include SUS, copper, nickel, and carbon.

Furthermore, in regard to the thickness, shape and other factors of the cathode current collector and the anode current collector, it is preferable to appropriately select the thickness, shape and other factors depending on the use of the all solid state battery, and the like.

For the battery case used in the present invention, any general battery case for an all solid state battery can be used. An example of the battery case may be a battery case made of SUS.

(5) All Solid State Battery

The all solid state battery of the present invention is capable of repeated charging and discharging and is useful as, for example, a battery for vehicles. Furthermore, examples of the shape of the all solid state battery of the present invention include a coin form, a laminate form, a cylindrical form, and a cubic form. Furthermore, the method for producing an all solid state battery of the present invention is not particularly limited as long as it is a method by which the all solid state battery described above can be obtained, and the same method as a general method for producing an all solid state battery can be used.

### 2. Second Embodiment

A second embodiment of the all solid state battery of the present invention is an all solid state battery comprising a cathode layer containing cathode active material particles and a sulfide solid electrolyte; an anode layer; and a solid electrolyte layer formed between the cathode layer and the anode layer, characterized in that in the cathode layer, a sulfide solid electrolyte layer having a layer thickness in the range of 500 nm to 1000 nm and containing a sulfide solid electrolyte is formed between the particles of the cathode active material particles.

FIG. 2B is a schematic cross-sectional diagram illustrating an example of the second embodiment of the all solid state battery of the present invention. The all solid state battery 20 illustrated in FIG. 2B comprises a cathode layer 4; an anode layer 5; a solid electrolyte layer 6 formed between the cathode layer 4 and the anode layer 5; a cathode current collector 7 that performs current collection of the cathode layer 4; and an anode current collector 8 that performs current collection of the anode layer 5. The present invention is characterized in that the sulfide solid electrolyte layer 2 formed between the cathode active material particles 1a, 1b and 1c contained in the cathode layer 4 are brought into contact with the particles at layer thicknesses 9a, 9b and 9c, respectively, which are all in the range of 500 nm to 1000 nm. In this case, the particle surfaces of the cathode active material particles 1a, 1b and 1c may not be entirely coated by the sulfide solid electrolyte layer 2.

According to the present invention, in regard to the cathode layer containing cathode active material particles and a sulfide solid electrolyte, when the layer thickness of the sulfide solid electrolyte layer formed between the cathode active material particles is adjusted to the layer thickness in the range described above, the particles of the cathode active material particles can be arranged at an optimal interparticle distance that maintains high lithium ion conductivity and results in a high packing density. Thereby, an all solid state battery having a high discharge capacity and high battery efficiency can be obtained.

Hereinbelow, the respective configurations of the second embodiment of the all solid state battery of the present invention will be explained.

Incidentally, in regard to the anode layer, solid electrolyte layer, and other configurations used in the second embodiment of the all solid state battery of the present invention, since the same matters as those described in the above section “1. First embodiment” are applicable, further description will not be repeated here.

(1) Cathode Layer

The cathode layer according to the second embodiment of the all solid state battery of the present invention comprises at least cathode active material particles, and a sulfide solid electrolyte layer that is formed between the cathode active material particles and contains a sulfide solid electrolyte, and may further comprise at least one of a conduction aid and a binding material as necessary.

(i) Cathode Active Material Particles

The content of the cathode active material particles in the cathode layer is not particularly limited, but the content is, for example, preferably in the range of 10% by mass to 99% by mass, and more preferably in the range of 20% by mass to 90% by mass.

Incidentally, regarding the cathode active material particles contained in the cathode layer, the same material as that used in the cathode active material particles contained in the electrolyte-coated cathode active material particles used in the above-described “1. First embodiment” can be used, and since the same matters as those described in the above section “A. Electrolyte-coated cathode active material particles” are applicable, further description will not be repeated here.

Furthermore, the cathode active material particles may also have a lithium ion conductive oxide layer on the surface. In regard to the lithium ion conductive oxide layer, since the same matters as those described in the above section “A. Electrolyte-coated cathode active material particles” are applicable, further description will not be repeated here.

(ii) Sulfide Solid Electrolyte Layer

The sulfide solid electrolyte layer in the cathode layer is a layer containing at least a sulfide solid electrolyte, and may further contain a conduction aid as necessary.

Incidentally, in regard to the sulfide solid electrolyte contained therein and the conduction aid used in the sulfide solid electrolyte layer, since the same matters as those described in the above section “A. Electrolyte-coated cathode active material particles” are applicable, further description will not be repeated here.

The content of the conduction aid contained in the sulfide solid electrolyte layer is not particularly limited, but the content is, for example, preferably in the range of 0.1% by mass to 20% by mass.

Furthermore, the content of the sulfide solid electrolyte in the sulfide solid electrolyte layer is an amount obtained by subtracting the contents of other materials described above from the total amount (100% by mass) of the sulfide solid electrolyte layer.

The content of the sulfide solid electrolyte layer in the cathode layer is not particularly limited, but the content is preferably in the range of 1% by mass to 90% by mass, and more preferably in the range of 10% by mass to 80% by mass.

Furthermore, in the cathode layer, the layer thickness of the sulfide solid electrolyte layer formed between adjacent cathode active material particles is preferably in the range of 500 nm to 1000 nm, more preferably in the range of 600 nm to 900 nm, and even more preferably in the range of 700 nm to 800 nm.

Incidentally, the layer thickness of the sulfide solid electrolyte layer means, as will be described below, the interparticle distance of the cathode active material particles that are brought into contact, with the sulfide solid electrolyte layer interposed between the particles.

Furthermore, examples of the method for measuring the layer thickness of the sulfide solid electrolyte layer include an image analysis using transmission electron microscopy (TEM). Incidentally, the layer thickness refers to an average layer thickness.

Here, the relationship between the interparticle distance of the cathode active material particles and the layer thickness of the sulfide solid electrolyte layer, and the relationship between the interparticle distance of the cathode active material particles and the battery characteristics in regard to the cathode layer of the all solid state battery of the present invention will be explained.

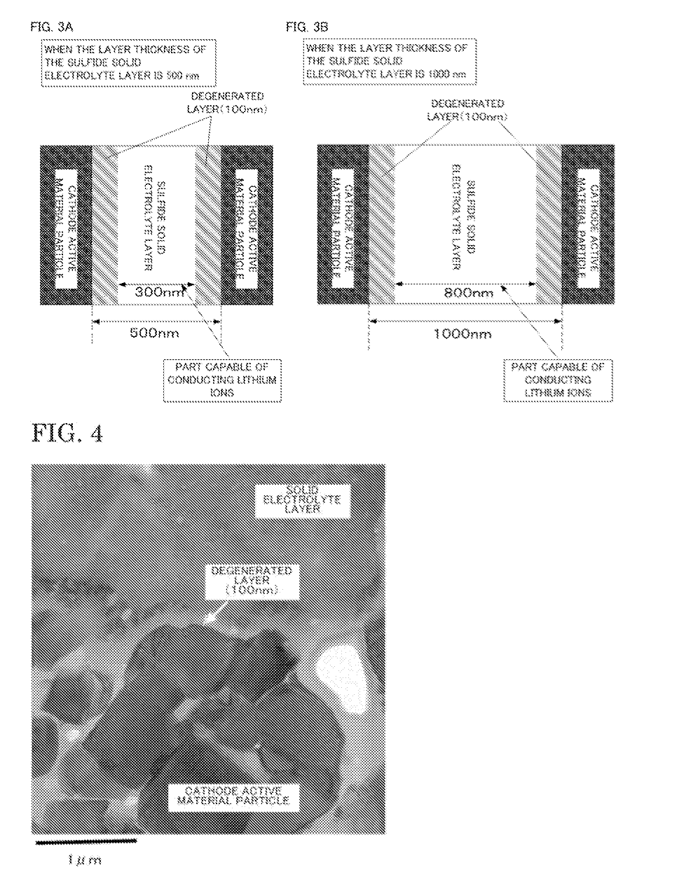

FIG. 3A and FIG. 3B are schematic cross-sectional diagrams illustrating an example of adjacent electrolyte-coated cathode active material particles. As illustrated in FIG. 3A and FIG. 3B, the interparticle distance of adjacent cathode active material particles is determined by the layer thickness of the sulfide solid electrolyte layer coated on the particle surfaces. Furthermore, FIG. 4 is a TEM image of electrolyte-coated cathode active material particles. As shown in FIG. 4, along the boundaries of the cathode active material particles and the sulfide solid electrolyte layer, a degenerated layer is usually formed as a result of deterioration of the sulfide solid electrolyte layer. This degenerated layer can be considered as a layer containing an oxide since the layer has a high oxygen concentration. In general, since the lithium ion conductivity of an oxide solid electrolyte is about 1/1000 of the lithium ion conductivity of a sulfide solid electrolyte, it is contemplated that the part capable of conducting lithium ions is the sulfide solid electrolyte layer part excluding the degenerated layer.

As shown in FIG. 3A, when the layer thickness of the sulfide solid electrolyte layer is 500 nm, and the degenerated layer is formed to a layer thickness of 100 nm at various boundaries, the interparticle distance of the cathode active material particles is 500 nm, and the cross-sectional area through which lithium ions can be conducted is 60%. On the other hand, as shown in FIG. 3B, when the layer thickness of the sulfide solid electrolyte layer is 1000 nm, and the degenerated layer is formed to the aforementioned layer thickness, the interparticle distance of the cathode active material particles is 1000 nm, and the cross-sectional area through which lithium ions can be conducted is 80%.

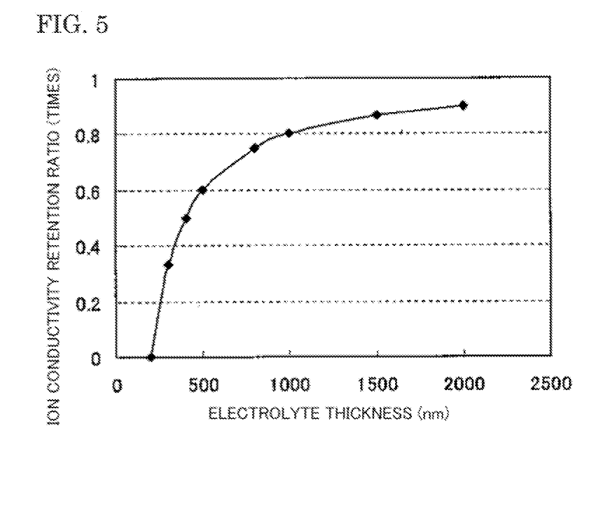

Next, FIG. 5 shows the layer thicknesses of the sulfide solid electrolyte layer when the layer thickness of the degenerated layer was adjusted to 100 nm, and the provisional calculation values of the lithium ion conductivity retention ratio at that time. When the layer thickness of the sulfide solid electrolyte layer is 500 nm or less, the lithium ion conductivity retention ratio is rapidly decreased. On the other hand, when the layer thickness is 1000 nm or more, an increase in the lithium ion conductivity retention ratio is hardly seen.

As can be seen from the relationship between the layer thickness of the sulfide solid electrolyte layer and the lithium ion conductivity retention ratio, if the layer thickness of the sulfide solid electrolyte layer, that is, the interparticle distance of the cathode active material particles, is too small, since the cross-sectional area of the sulfide solid electrolyte layer that can conduct lithium ions is also decreased, lithium ion conductivity is decreased, and the battery efficiency of the all solid state battery is decreased. On the other hand, if the interparticle distance of the cathode active material particles is too large, there is no change in the enhancement of lithium ion conductivity; however, since the packing density of the cathode active material particles in the cathode layer is decreased as compared with the case in which the interparticle distance is larger, the discharge capacity of the all solid state battery is decreased.

### 3. Third Embodiment

A third embodiment of the all solid state battery of the present invention is an all solid state battery comprising a cathode layer containing cathode active material particles and a sulfide solid electrolyte; an anode layer; and a solid electrolyte layer formed between the cathode layer and the anode layer, characterized in that in a cross-sectional region of the cathode layer, when the area of the sulfide solid electrolyte present in a region in which the distance between the cathode active material particles is 1000 nm or less is designated as S_{A}, and the total area of the sulfide solid electrolyte is designated as S_{B}, the ratio S_{A}/S_{B} is 0.1 or greater.

According to the present invention, when the ratio S_{A}/S_{B} is in a predetermined range, the interparticle distance of adjacent cathode active material particles can be arranged uniformly with high accuracy, such that the interparticle distance would be an interparticle distance that can maintain lithium ion conductivity and has a high packing density in the cathode layer. Thereby, an all solid state battery having improved battery efficiency with a high discharge capacity can be obtained.

Hereinbelow, the respective configurations of the third embodiment of the all solid state battery of the present invention will be explained.

Incidentally, in regard to the anode layer, solid electrolyte layer, and other configurations used in the third embodiment of the all solid state battery of the present invention, since the same matters as those described in the above section “1. First embodiment” are applicable, further description will not be repeated here.

Furthermore, the above ratio S_{A}/S_{B} is usually 0.1 or greater, preferably in the range of 0.15 to 1, and more preferably in the range of 0.25 to 1. The value of the ratio S_{A}/S_{B} can be determined as follows. That is, a cross-section of the cathode layer is observed using scanning electron microscopy (SEM), and a predetermined region (for example, a region measuring 50 μm×50 μm) is specified. In that predetermined region, an area corresponding to S_{A} and S_{B} is specified by an imaging process, and the value of the ratio S_{A}/S_{B} can be determined. Furthermore, as described in connection with the second embodiment, the layer thickness of the sulfide solid electrolyte layer formed between adjacent cathode active material particles is preferably in the range of 500 nm to 1000 nm. Thus, when the area of the sulfide solid electrolyte present in a region in which the distance between the cathode active material particles is in the range of 500 nm to 1000 nm is designated as S_{A1}, the ratio S_{A1}/S_{A} is preferably 0.2 or greater, more preferably in the range of 0.3 to 0.9, and even more preferably in the range of 0.5 to 0.8.

Furthermore, in regard to the cathode active material particles used in the cathode layer, the solid electrolyte, and other items, since the same matters as those described in the above sections “1. First embodiment” and “2. Second embodiment” are applicable, further description will not be repeated here.

C. Method for Producing Electrolyte-Coated Cathode Active Material Particles

Next, the method for producing electrolyte-coated cathode active material particles of the present invention will be described. The method for producing electrolyte-coated cathode active material particles of the present invention comprising a coating step of subjecting a mixture of cathode active material particles and a solid electrolyte to a shear force imparting treatment, and coating the solid electrolyte on the surface of the cathode active material particles.

According to the present invention, when a mixture obtained by mixing a cathode active material particles and a sulfide solid electrolyte is subjected to a shear force imparting treatment, the sulfide solid electrolyte can be coated closely to the surface of the cathode active material particles. Furthermore, in the coating step based on a shear force imparting treatment, the layer thickness of the sulfide solid electrolyte layer can be adjusted.

Hereinbelow, the method for producing electrolyte-coated cathode active material particles of the present invention will be explained.

1. Coating Step

The coating step according to the present invention will be described. The coating step of the present invention is a process of subjecting a mixture of cathode active material particles and a sulfide solid electrolyte to a shear force imparting treatment, and forming the sulfide solid electrolyte layer described above on the surface of the cathode active material particles.

(1) Mixture

The mixture for the present process contains cathode active material particles and a sulfide solid electrolyte, and the cathode active material particles and the sulfide solid electrolyte exist therein without having an interaction. The mixture for the present process may further contain at least one of a conduction aid and a binding material. In regard to the conduction aid and the binding material, the same matters as those described in the above section “B. All solid state battery” are applicable.

(i) Cathode Active Material Particles

The content of the cathode active material particles in the mixture of the present process is, for example, preferably in the range of 10% by mass to 99% by mass, and more preferably in the range of 20% by mass to 90% by mass. It is because if the content of the cathode active material particles in the mixture is too high, there is a possibility that particles that are not at all coated with the sulfide solid electrolyte, or particles that are partially not coated, may be produced. Furthermore, it is because if the content is too low, since there are fewer particles that carry out insertion and extraction of lithium ions, there is a possibility that the discharge capacity may be decreased.

Incidentally, in regard to the cathode active material particles used in the present process, since the same matters as those described in the above section “A. Electrolyte-coated cathode active material particles” are applicable, further description will not be repeated here.

The cathode active material particles used in the present process are preferably such that the particle surface is coated in advance with a lithium ion conductive oxide layer. It is because if a lithium ion conductive oxide is incorporated while the cathode active material particles and the sulfide solid electrolyte are mixed, or after the cathode active material particles and the sulfide solid electrolyte are mixed, there is a possibility that a lithium ion conductive oxide layer may not be formed between the cathode active material particles and the sulfide solid electrolyte layer, and the interface resistance occurring at the interface between the cathode active material particles and the sulfide solid electrolyte may not be suppressed.

Incidentally, in regard to the lithium ion conductive oxide layer, the same matters as those described in the above section “A. Electrolyte-coated cathode active material particles” are applicable, and thus further description will not be repeated here.

(ii) Sulfide Solid Electrolyte

The content of the sulfide solid electrolyte in the mixture of the present process is, for example, preferably in the range of 1% by mass to 90% by mass, and more preferably in the range of 10% by mass to 80% by mass. It is because if the content of the sulfide solid electrolyte in the mixture is too high, the layer thickness of the sulfide solid electrolyte layer formed on the surface of the cathode active material particles becomes thick, and the electrolyte-coated cathode active material particles in the cathode layer cannot be arranged at an appropriate interparticle distance. Furthermore, it is because when a portion of the sulfide solid electrolyte remains in the cathode layer without coating the particles, there is a possibility that the cathode active material particles may not be packed densely, and the discharge capacity may decrease. Furthermore, it is because if the content is too low, there is a possibility that a coating layer may not be sufficiently formed on the surface of the cathode active material particles, and the lithium ion conductivity may decrease.

Incidentally, in regard to the sulfide solid electrolyte used in the present process, the same matters as those described in the above section “A. Electrolyte-coated cathode active material particles” are applicable, and thus further description will not be repeated here.

(2) Coating Step

The coating step of the present process is a process of subjecting a mixture of the cathode active material particles and the sulfide solid electrolyte to a shear force imparting treatment, and forming a sulfide solid electrolyte layer on the surface of the cathode active material particles. The shear force imparting treatment may be carried out such that a shear force may be imparted simultaneously with mixing of the aforementioned materials in the operation of mixing the cathode active material particles and the sulfide solid electrolyte, or after mixing of the cathode active material particles and the sulfide solid electrolyte is sufficiently achieved, a shear force may be imparted to a mixture thus obtained.

Incidentally, examples of the method for confirming that the sulfide solid electrolyte layer has coated on the surface of the cathode active material particles by the shear force imparting treatment, and electrolyte-coated cathode active material particles have been formed, include transmission electron microscopy (TEM) and X-ray photoelectron spectroscopy (XPS).

(i) Shear Force Imparting Treatment

The magnitude of the shear force for the present process is preferably a magnitude capable of forming a sulfide solid electrolyte layer by coating the sulfide solid electrolyte to closely adhere to the surface of the cathode active material particles. For example, the magnitude is preferably 5 N or greater, and more preferably in the range of 10 N to 2000 N.

Furthermore, regarding the method for imparting a shear force in the present process, there are no particular limitations as long as the method is a method capable of sufficiently coating a sulfide solid electrolyte on the surface of cathode active material particles, and thereby forming a sulfide solid electrolyte layer. For example, in the case of producing the particles in a small scale such as in a laboratory, a method of pulverizing with a manual or automatic mortar may be used, and in a case intended for a large-scale production, a method of using a wet pulverization apparatus and a kneading apparatus that can impart a high shear force, such as a ball mill, a roller mill or a vibrating mill, may be used.

There are no particular limitations on the time for imparting a shear force to the mixture, but generally, the time is preferably in the range of 1 minute to 120 minutes.

The method for producing electrolyte-coated cathode active material particles of the present invention may appropriately include any arbitrary processes as necessary, in addition to the coating step, which is an essential process. Examples of such processes include foreign material removal step and classification step.

Incidentally, the present invention is not intended to be limited to the exemplary embodiment described above. The above-described exemplary embodiment is described only for illustrative purposes, and any embodiment having substantially the same structure as the technical idea described in the claims of the present invention, and providing similar operating effects, will be included in the technical scope of the present invention.

### EXAMPLES

Hereinafter, the present invention will be described more specifically by way of Examples.

### Synthesis Example 1

### Production of Sulfide Solid Electrolyte 75Li₂S-25P₂S₅

For the starting raw materials, Li₂S (manufactured by Nippon Chemical Industrial Co., Ltd.) and P₂S₅ (manufactured by Sigma-Aldrich Co. LLC.) were used. Next, in a glove box in an argon atmosphere (dew point: −70° C.), 0.7675 g of Li₂S and 1.2344 g of P₂S₅ (a molar ratio of 75Li₂S-25P₂S₅) were weighed. This mixture was mixed in an agate mortar for 5 minutes. Thereafter, the mixture thus obtained was introduced into a 45-ml container for planetary ball mill, and 4 g of dehydrated heptane was introduced therein. Furthermore, ten ZrO₂ balls (φ=10 mm) were introduced therein, and the container was perfectly sealed (Ar atmosphere). This container was mounted in a planetary ball mill machine, and mechanical milling was performed for 40 hours at a speed of rotation of 300 rpm. Subsequently, a sample thus obtained was dried on a hot plate to remove heptane, and thus a sulfide solid electrolyte (75Li₂S-25P₂S₅) was obtained.

### Synthesis Example 2

### Production of Anode Mix Material

Weighed were 9.06 mg of graphite (anode active material, manufactured by Mitsubishi Chemical Corp.) and 8.24 mg of the sulfide solid electrolyte, and these were mixed to obtain an anode mix material.

### Example 1

### Production of Electrolyte-Coated Cathode Active Material Particles

Weighed were 5.03 mg of the sulfide solid electrolyte and 5.03 g of VGCF (vapor phase-grown carbon fiber, conduction aid, manufactured by Showa Denko K.K.) and mixed in a mortar for 10 minutes. Subsequently, 12.03 mg of LiNi_{1/3}Co_{1/3}Mn_{1/3}O₂ (cathode active material particles, manufactured by Nichia Corp.) was added thereto, and the mixture was mixed in a test tube mixer for 5 minutes. A shear force was applied to the mixture thus obtained using a mortar for 3 minutes, and thus a cathode mix material containing electrolyte-coated cathode active material particles was obtained. The layer thickness of the sulfide solid electrolyte layer covering the cathode active material particles was 300 nm, and the proportion of regions in which the layer thickness was larger than 1000 nm was 25%. Furthermore, the coating ratio of the sulfide solid electrolyte layer was 85%.

(Production of Battery for Evaluation)

Added was 18 mg of the sulfide solid electrolyte to a 1-cm² mold made of SUS and was pressed at a pressure of 1 ton/cm². Thus, a solid electrolyte layer was formed. On one surface side of the solid electrolyte layer thus obtained, 17.57 mg of the cathode active material was added, and the resultant was pressed at a pressure of 1 ton/cm². Thus, a cathode layer was formed. Next, on the other surface side of the solid electrolyte layer, 17.3 mg of the anode mix material described above was added, and the resultant was pressed at a pressure of 4 ton/cm². Thus, an anode layer was formed, and a battery for evaluation was obtained.

### Example 2

A battery for evaluation was obtained in the same manner as in Example 1, except that instead of applying a shear force to the mixture obtained as described above, a ball mill treatment was carried out using 4 g of heptane as a solvent, and using ten ZrO₂ balls (φ=10 mm) at 100 rpm for one hour. The layer thickness of the sulfide solid electrolyte layer covering the cathode active material particles was 200 nm, and the proportion of regions in which the layer thickness was larger than 1000 nm was 15%. Furthermore, the coating ratio of the sulfide solid electrolyte layer was 90%.

### Comparative Example

A battery for evaluation was obtained in the same manner as in Example 1, except that a shear force was not applied to the mixture obtained as described above.

[Evaluation 1]

(Cross-Sectional SEM Analysis)

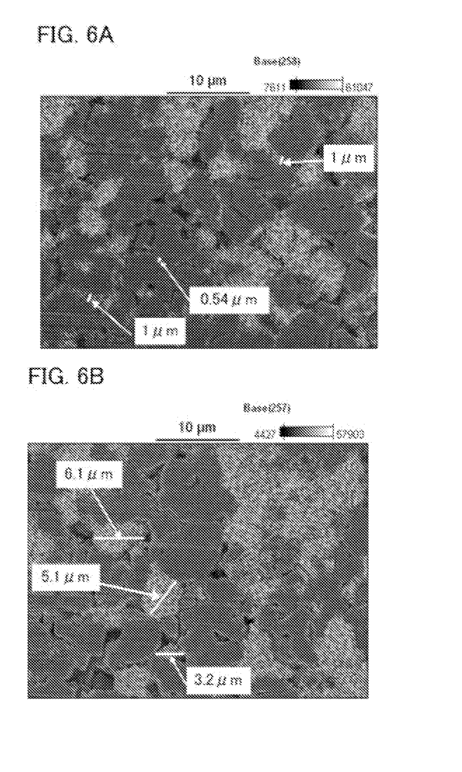

Cross-sections of the cathode layers of the batteries for evaluation obtained in Example 1 and Comparative Example were observed using SEM. The results are presented in FIGS. 6A and 6B. FIG. 6A is a cross-sectional SFM image of the cathode layer of Example 1, and FIG. 6B is the SEM image of Comparative Example. The distribution of the sulfide solid electrolyte is presented using white points by elemental mapping. In FIG. 6A, the cathode layer was formed after obtaining electrolyte-coated cathode active material particles, by applying a shear force to the mixture described above, and it was confirmed that the layer thickness of the sulfide solid electrolyte layer formed between the cathode active material particles was 1 μm or less. On the other hand, in FIG. 6B, the cathode layer was formed without applying a shear force to the mixture described above, and it was confirmed that the sulfide solid electrolyte layer formed between the cathode active material particles had a layer thickness of 1 μm or larger, and the layer thickness of that sulfide solid electrolyte layer varied largely from areas to areas. Furthermore, in the cross-section of the cathode layer of the battery for evaluation obtained in Example 1, the ratio S_{A}/S_{B} was 0.3, and the ratio S_{A1}/S_{A} was 0.8. On the other hand, in the cross-section of the cathode layer of the battery for evaluation obtained in Comparative Example, the ratio S_{A}/S_{B} was 0.05.

[Evaluation 2]

(Measurement of Discharge Capacity and Reaction Resistance)

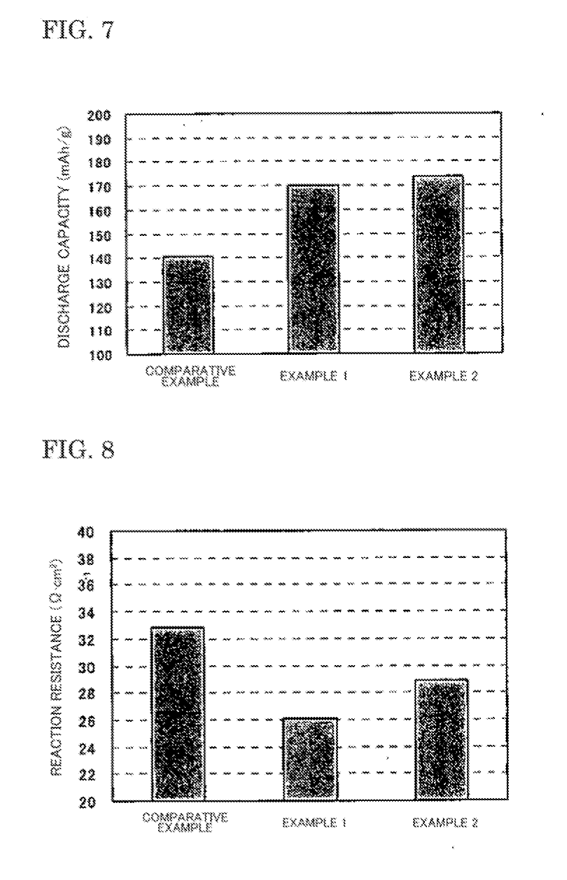

The batteries for evaluation obtained in Example 1, Example 2, and Comparative Example were used to perform CC charging at 0.3 mA up to 4.2 V, and discharging was performed at 0.3 mA to 2.5 V. Thereafter, the batteries were charged to 3.5 V, and the voltage was adjusted. An impedance analysis was performed using an interface impedance analyzer (manufactured by Solartron Group), and thus the interface resistance was determined. The results of the discharge capacity are presented in FIG. 7, and the results of the reaction resistance are presented in FIG. 8. As shown in FIG. 7, the discharge capacities of Example 1 and Example 2 exhibited higher values than that of Comparative Example. In Example 1 and Example 2, a sulfide solid electrolyte layer is coated on the surface of the cathode active material particles by applying a shear force to the mixture described above, and it is contemplated that the sulfide solid electrolyte layer thus formed is closely adhering to the surface of the cathode active material particles. It is contemplated that thereby, there were fewer voids in the cathode layer, the packing density was increased by densely packing the cathode active material particles, and the discharge capacity was increased.

Furthermore, as shown in FIG. 8, it can be seen that Example 1 and Example 2 have lower resistance than Comparative Example. That is, it is suggested that when a sulfide solid electrolyte is coated to closely adhere to the surface of cathode active material particles by applying a shear force to the mixture described above, the number of lithium ion conduction paths is increased, and the reaction resistance occurring when lithium ions are conducted is suppressed. Furthermore, when Example 1 and Example 2 are compared, it is shown that Example 1 has further lower reaction resistance. In this regard, it is contemplated that since a sulfide solid electrolyte layer is coated by a shear force imparting treatment in Example 1, while a sulfide solid electrolyte layer is coated by a ball mill treatment in Example 2, applying a shear force imparting treatment can impart a stronger shear force to the mixture, and the adhesiveness to the surface of the cathode active material particles is further increased. Therefore, it is believed that the reaction resistance was suppressed.

### REFERENCE SIGNS LIST

1, 1a, 1b, 1c cathode active material particles
2 sulfide solid electrolyte layer
3 lithium ion conductive oxide layer
4 cathode layer
5 anode layer
6 solid electrolyte layer
7 cathode current collector
8 anode current collector
9a, 9b, 9c layer thickness
10 electrolyte-coated cathode active material particles
20 all solid state battery

1. An electrolyte-coated cathode active material particle, comprising a cathode active material particle; and a sulfide solid electrolyte layer formed on a surface of the cathode active material particle; and a lithium ion conductive oxide layer between the cathode active material particle and the sulfide solid electrolyte layer,
wherein a layer thickness of the sulfide solid electrolyte layer is in the range of 50 nm to 1000 nm.

2-3. (canceled)

4. An all solid state battery comprising a cathode layer; an anode layer; and a solid electrolyte layer formed between the cathode layer and the anode layer,
wherein the cathode layer contains the electrolyte-coated cathode active material particle according to claim 1.

5. An all solid state battery comprising a cathode layer containing a cathode active material particle and a sulfide solid electrolyte; an anode layer; and a solid electrolyte layer formed between the cathode layer and the anode layer,
wherein in a cross-sectional region of the cathode layer, when an area of the sulfide solid electrolyte existing in a region in which a distance between the cathode active material particles is 1000 nm or less is designated as S_{A}, and a total area of the sulfide solid electrolyte is designated as S_{B}, a ratio S_{A}/S_{B} is 0.1 or greater.

6. A method for producing an electrolyte-coated cathode active material particle, the electrolyte-coated cathode active material particle being the electrolyte-coated cathode active material particle according to claim 1, the method comprising a coating step of subjecting a mixture of a cathode active material particle and a sulfide solid electrolyte to a shear force imparting treatment, and coating the sulfide solid electrolyte on a surface of the cathode active material particle.
